(19) United States
(12) Patent Application Publication
(10) Pub. No.: US 2008/0113877 A1
(43) Pub. Date: May 15, 2008

(54) Liquid solution deposition of composition gradient materials

(75) Inventor: Yi-Qun Li, Danville, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/893,597

(22) Filed: Aug. 16, 2007

Related U.S. Application Data
(60) Provisional application No. 60/838,509, filed on Aug. 16, 2006.

(51) Int. Cl. B32B 27/00

(52) U.S. Cl. 506/20; 422/100; 428/411.1; 506/32

(57) ABSTRACT

Disclosed herein are systems and methods of producing compositional gradient combinatorial libraries, and the product libraries that result from a reaction between different components of the precursor library. The combinatorial libraries of the present embodiments comprise a compositional gradient of at least two polymer-stabilized liquids deposited on a substrate, where the polymer-stabilized liquids are solutions of inorganic materials.

### CROSS REFERENCE TO RELATED APPLICATION

This application claims the benefit of priority to U.S. Provisional Application No. 60/838,509, filed Aug. 16, 2006, the specification and drawings of which are incorporated herein by reference.

### BACKGROUND OF THE INVENTION

1. Field of the Invention

Embodiments of the present invention are directed to systems and methods of preparing combinatorial libraries of polymer-stabilized liquid solutions in a gradient of compositions on a substrate. The gradient of compositional materials may be reacted on the substrate, and the resultant compositional gradient libraries analyzed for electrical, dielectric, magnetic, mechanical, chemical, and optical properties, including luminescence, crystal nucleation, superconductivity, and the like.

2. Description of the Related Art

Combinatorial libraries are useful for screening compositions for unique or improved characteristics. In the biosciences, combinatorial arrays can be useful in discovery of molecules with desirable binding or catalytic activities. In materials sciences, combinatorial libraries have been constructed to discover materials with useful physical, catalytic, chemical, mechanical, or optical characteristics. Combinatorial technologies can provide efficient ways to create and screen materials useful in medicine, electronics, optics, packaging, machinery, and more.

The use of combinatorial libraries can be found in many fields, including printing, mathematics, video display, art, life sciences, electronics, and the like. Such libraries typically include many elements with common characteristics grouped in homogenous zones of the library to form interesting or useful patterns (such as, images, textures, or environments). Combinatorial libraries typically include substrates with randomly or systematically different constituents combined at different locations. Large scale combinatorial libraries can include extensive arrays of different materials combinations at different locations providing screenable populations containing variety of useful properties.

What is needed in the art, therefore, is a way of stabilizing liquid gradient libraries of materials, including solutions of high valence ions, such that the array may be stored for further processing. It is contemplated that such an intermediate array may be commercialized in that stabilized condition, such that another investigator or commercial entity may further process the array according to its own proprietary interests.

The present inventors have developed systems and methods for controlling and maintaining a stable distribution of metal ions in solution at the molecular level, thus ensuring a homogeneous mixture, and these techniques are particularly useful when processing or transferring a liquid master array either to a substrate or to an intermediate liquid array. According to these methods, a metal precursor and a soluble polymer are reacted to form a solution that does not suffer from the conventional problems of gelling or precipitation. The polymer actively binds the metal ion(s) and serves to encapsulate the metal, prevent chemical reactions between constituent ions of the mixture, and maintain the ions in a uniform distribution within the solution. In other words, the polymer functions to ensure a homogeneous metal ion distribution in the solution, and to isolate ions from one another to prevent unwanted reactivity between the metal ion constituents. The stabilized array at this stage could be the master array or a replicate array, and it may comprise an array that exists prior to the final deposition onto a substrate to create the product array. Such stabilized liquid solutions (existing as individual members of an array) may be stable, according to the present embodiments, for up to months at a time.

In view of the above, a need exists for systems and methods to reliably and reproducibly prepare combinatorial arrays of inorganic materials through liquid solutions. It would be desirable to have systems to readily prepare replicate arrays of a homogeneous, well mixed, and stable liquid solution on a practical substrate. The present invention provides these and other features that will be apparent upon review of the following.

### SUMMARY OF THE INVENTION

Embodiments of the present invention are directed to compositional gradients of combinatorial materials libraries, where the libraries comprise a compositional gradient of at least two polymer-stabilized liquids deposited on a substrate. The gradient may be of a continuous nature, a linear nature, or a non-linear nature. The compositional gradient combinatorial materials library may comprise a gradient of the first polymer-stabilized liquid ranging from about 100 percent at a first location of the library, and continuously decreases to about zero percent at a second location of the library, and a gradient of the second polymer-stabilized liquid ranging from about 100 percent at the second location of the library, and continuously decreases to about zero percent at the first location of the library.

The polymer-stabilized liquids of the combinatorial library may comprise an inorganic material selected from the group consisting of metals, ions, elements, or molecules without carbon-hydrogen bonds in a solution wherein the solvent is selected from the group consisting of an aqueous-based solvent, a polar solvent, an organic solvent, and a hydrophobic liquid solvent.

Additional embodiments of the present invention include the product compositional gradient combinatorial library formed from a reaction between a polymer-stabilized liquid solution and a second polymer-stabilized liquid solution, and systems for producing a compositional gradient combinatorial library. Such systems comprise a reservoir of a first polymer-stabilized liquid solution, and a pump connected to the reservoir, for delivering the first polymer-stabilized liquid solution to a dispenser; a reservoir of a second polymer-stabilized liquid solution, and a pump connected to the reservoir, for delivering the second polymer-stabilized liquid solution to the disperser; and a substrate on which are deposited the first and second polymer-stabilized solutions according to a desired compositional gradient. The system may further include a thermal regulatory system adjacent to the substrate for heating and cooling the compositional gradient combinatorial library, and thus causing reaction between the first and second polymer-stabilized liquid solutions.

Alternatively, a system for producing a compositional gradient combinatorial library may comprise a reservoir of a first polymer-stabilized liquid solution, and a pump connected to the reservoir, for delivering the first polymer-stabilized liquid solution to a first dispenser; a reservoir of a second polymer-stabilized liquid solution, and a pump connected to the reservoir, for delivering the second polymer-stabilized liquid solution to a second disperser, the second dispenser spaced apart from the first dispenser; and a substrate on which are deposited the first and second polymer-stabilized solutions according to a desired compositional gradient.

### BRIEF DESCRIPTION OF THE DRAWINGS

FIG. 1 is a flow rate control method for the liquid solution deposition of a material in the form of a compositional gradient, illustrating the case for a two-component system where one dispenser dispenses the two liquids, so compositional control is achieved by flow rate; and

FIG. 2 is an illustration of an embodiment whereby at least two liquid solutions are dispensed one at a distance from the other, such that compositional control is achieved by the fact that flux varies with distance from the dispenser.

### DETAILED DESCRIPTION OF THE INVENTION

Disclosed herein are systems and methods of producing a combinatorial library of polymer-stabilized liquid solutions in a compositional gradient manner, rather than creating a library in the form of an array with discrete array members. In the following description, the nature of the inorganic solutions will be discussed first, followed by a discussion of substrates, then the reactions that may take place between the precursor materials as they are deposited in a compositional gradient (linear or non-linear) manner on the substrate. After that two exemplary systems for preparing the instant gradient combinatorial libraries will be discussed, concluding with analytical measurements that may be made on the libraries.

### Inorganic Material Solutions

Inorganic materials of interest for application in compositional gradient libraries of the invention can be elements, ions, or molecules without carbon-hydrogen bonds. For application to substrates, the inorganic materials form solutions in a liquid form. The liquid can be aqueous, a polar solvent, organic solvents, and/or a hydrophobic liquid. The materials can be associated with one or more polymers, which stabilize the solution of materials.

Many useful inorganic materials of interest in the invention include metals in the elemental form or in the form of a metal compound. For example, the inorganic materials can comprise elemental forms, ionized forms, and/or compounds of: aluminum, antimony, barium, bismuth, boron, cadmium, calcium, carbon, cerium, chromium, cobalt, copper, dysprosium, erbium, europium, gadolinium, germanium, gold, hafnium, holmium, indium, iridium, iron, lanthanum, lead, lithium, lutetium, magnesium, manganese, molybdenum, neodymium, nickel, niobium, palladium, platinum, polonium, praseodymium, rhenium, rhodium, ruthenium, samarium, scandium, selenium, silicon, silver, strontium, tantalum, tellurium, terbium, thallium, thulium, tin, titanium, tungsten, vanadium, ytterbium, yttrium, zinc, zirconium, oxidized forms thereof, ionized forms thereof, and/or the like. Ionized forms can include metal salts, such as carbonates, nitrates, phosphates, chlorides, acetates, chelated forms, and/or the like.

Polymers useful in the present invention can stabilize the inorganic materials in solution. Stabilizing, as used with regard to polymers herein, refers to interactions with inorganic materials of interest so that they can be applied consistently using methods of the invention. In general, in at least one stage of the processing of the present combinatorial gradients, a polymeric solution is mixed with a metal ion solution to effect the stabilized array. The polymeric solution may be prepared by dissolving a polymer such as polyethyleneimine (C₂H₅N)ₙ in water. Other components such as ethylenediaminetetraaceticacid (EDTA, C₁₀H₁₆N₂O₈) may be added to this solution. Next, the corresponding salt of the metal ion under investigation in the combinatorial library is prepared by dissolving the salt in water. In one embodiment of the present invention, nitrates may be used. The metal ion solution is then mixed with the polymer solution such that the polymer/EDTA encapsulates the metal ion(s). In some instances, it may be necessary to add either an acid or a base to the polymer/EDTA metal salt solution to assist with the encapsulation.

Other polymers that may be used in conjunction with EDTA to encapsulate the metal ion and stabilize the liquid array include a polyanionic polymer, a polycationic polymer, mixed ionic polymers, a peptide, polyethyleneimine (PEI), heparin, carboxylated polyethyleneimine (PEIC), polyethylene oxide, polyelectrolytes, polyacrylate, perfluorosulphonate, perfluorocaboxylate, acrylamide, polyacrylic acid, polyacrylonitrile, a polynucleotide, a protein, polycarbonate, diethylaminoethyl-dextran, dextran sulfate, polyglutamic acid, polyphosphate, polyborate, nitrilotriacetate (NTA), ethylene diamine tetraacetate (EDTA) groups, poly histidine, DMPS, DMSA. DMSO, Bipyridyl, Ethyleneglycol bis2-aminoethyl tetraacetic acid (EGTA), Hydroxyethylethylenediamine triacetic acid (HEDTA), hydroxyethyl starch (HES), dextran, dextrin, inulin, polyvinyl pyrrolidone (PVP), polystyrene, and/or the like.

Virtually any metal in the periodic table may be used in the present embodiments. For example, the metal may comprise a group IA element, such as Li, Na, K, Rb, or Cs. These ions are monovalent. Alternatively, the metal may comprise a divalent ion from the group IIA alkaline earth metal column such as Ca, Sr, Ba, Mg, or other divalent metal ions such as Co, Mn, Zn, and Pb. Trivalent metal ions include Al, Ga, La, Ce, Pr, Nd, Po, Sm, Eu, Gd, Tb, Dy, Ho, Er, Tm, Yb, Lu, Y, Bi, and Cr. Metal ions and/or semiconducting elements having a quaternary valence include Ge, Zr, Hf, and Sn. Metal ions and inorganic non-metal elements having a valence of V that may be stabilized according to the present embodiments include V and P, metals with a valence of VI are Mo and W.

For example, the stabilizing polymer are soluble in the application liquid of choice, and can have ionic properties, chelating properties, and/or viscosity enhancing properties that interact with the inorganic material to promote uniform distribution in the liquid. Stabilizing polymers can help retain uniform distribution of the materials while the liquids are handled during application processes and/or while liquids are held in storage between processes. Some stabilizing polymers can have the useful property of reducing oxidation and/or precipitation of the inorganic material.

In embodiments where the inorganic material exists as an ion in solution, the stabilizing polymer can have ionic groups of the opposite charge so that the material forms an ionic association with the polymer. The solubility, suspension, and/or structural matrix (e.g., intertwined or cross-linked gel matrix) of the polymer can also help maintain uniform distribution of the ionic material in the application liquid. The ionic polymer can exchange with the counter ion of the ionic material to avoid solubility limitations of the ion with the counter ion. With the inorganic material ion associated (e.g., with ionic bonds) to the polymer, undesirable counter ions and other impurities can be removed from the application liquid, e.g., by ultrafiltration or dialysis. Ionic stabilizing polymers can include, e.g., polyanions, poly cations, mixed ionic polymers, peptides, nucleotides, polyethyleneimine (PEI), heparin, carboxylated polyethyleneimine (PEIC), polyethylene oxide, polyelectrolytes, polyacrylate, perfluorosulphonate, perfluorocaboxylate, acrylamide, polyacrylic acid, polyacrylonitrile, a polynucleotide, a protein, polycarbonate, diethylaminoethyl-dextran, dextran sulfate, polyglutamic acid, polyphosphate, polyborate, and the like.

Where the inorganic material is an ionic material, the stabilizing polymer can beneficially comprise some chelating character. Metal ions, such as ions of alkaline-earth metals and many transition metals, can be stabilized in the material combination solution by association with polymers having available chelating groups. For example, stabilizing polymers can have chelating groups, such as nitrilotriacetate (NTA), ethylene diamine tetraacetate (EDTA) groups, poly histidine, DMPS, DMSA. DMSO, bipyridyl, ethyleneglycol bis2-aminoethyl tetraacetic acid (EGTA), hydroxyethylethylenediamine triacetic acid (HEDTA), and/or the like.

Where an inorganic material tends to form non-homogenous distributions in an application liquid (e.g., where the material is a particle, precipitates, adsorbs onto surfaces, or falls out of suspension), a viscous polymer or supportive polymer matrix can help maintain a uniform dispersal of the material in the liquid long enough to provide uniform, consistent or repeatable transfer and application to a substrate. Stabilizing polymers that enhance viscosity of application solutions can provide benefits when used in the methods and systems of the invention. The presence of viscous polymers in the application solution can help retain homogeneity of the material in the liquid. Settling of suspended, but insoluble, inorganic materials can be reduced in the presence of viscous polymers. Viscous polymers can reduce convection in the liquids, e.g., thus reducing exposure of the materials to undesirable reactants such as oxygen or water during storage of the liquid. Desirable viscosity enhancing stabilizing polymers increase the viscosity of the liquid by at least 50%, or enhance viscosity of the liquid by at least 10 centipoise (cP). Preferred viscosity enhancing stabilizing polymers are present in the liquid in amounts adequate to increase the viscosity by about 100 cP, by about 1000 cP, about 10⁴ cP, about 10⁵ cP, about 10⁶ cP, about 10⁷ cP or more. Stabilizing polymers described above can provide beneficial viscosity increases. Other useful viscosity enhancing stabilizing polymers include, e.g., hydroxyethyl starch (HES), dextran, dextrin, inulin, or polyvinyl pyrrolidone (PVP), polystyrene, and the like.

Another benefit derived from many viscosity enhancing stabilizing polymers is improved interaction between the combination solution and the substrate. Polymers can increase the affinity of the liquid for the substrate (e.g., make it more sticky) so it retains contact with the substrate after it is applied. The more viscous liquids can flow more slowly so they don't migrate excessively from array locations during processing steps.

In other embodiments, inorganic materials are retained in homogenous solutions by selection of solvents and/or counter ions that help avoid precipitation of the material. For example, many metals have enhanced solubility in solution as nitrates. Optionally, certain nonaqueous solvents (e.g., organic or silicone solvents) can be employed to retain some materials in solution.

### Substrates

A substrate is generally a rigid or semi-rigid material having a surface onto which liquids containing inorganic materials can be applied. Substrates can have a shape suited to particular composition gradient library fabrication processes, and component reaction and analysis techniques. Substrates can be formed from materials that tolerate handling and process conditions, such as high temperatures and exposure to liquids.

Substrates are typically thermostable solids having a flat material application surface. For example, a substrate can be a flat ceramic disk not substantially deteriorated by temperatures of between about 450° C. and 2000° C. in the presence of air. In other embodiments, substrates can be fabricated from, glass, metal, graphite, silicon, alumina, carbon composites, ceramics, polymers, and/or the like. The substrate can be shaped like a disk, a card, a cylinder, a sphere, a cube, etc. In some embodiments, the substrate can be in the form of two or more beads.

The surface of a substrate can have locations suitable for processing, holding, and presenting a combinatorial array of inorganic compositions. The surface can be smooth and uniform to provide easy precision contact with devices used in certain replication processes. The substrate surface can be rough or porous to absorb and/or hold applied materials. The substrate surface can have locations defined by borders, such as channels, ridges, hydrophobic regions, hydrophilic regions, and/or the like, to retain transferred materials at a particular location in a replicate array.

The surface can include reference markers useful in orientation of application devices. For example, the edge of the surface can include physical references, such as holes, slots, or pins that interact with an application device frame to hold the substrate in place relative to the device as materials are applied to the surface. The reference markers can be two or more dots, or other indicia printed on the surface for alignment with certain points on an application device stage, for precise manual placement of the substrate in an application device, or for detection by an imaging system to confirm proper alignment of the substrate in an application device.

### Reactions of or Between Combinatorial Libraries

Mixtures of two or more different inorganic materials in a liquid solution form at locations in a compositional gradient library may react to form a new compositional gradient combinatorial array of reaction product compositions. In some cases, the different materials will react spontaneously on contact with other materials. In many cases, reaction of the material combinations is initiated by exposure of the replicate array to certain physical or chemical conditions. The term “reaction” as used herein, refers to chemical and/or physical combination of inorganic materials at an array location forming a reaction product composition molecule, crystal, amalgam, sinter product, or alloy of the materials. Reactions at locations on a substrate may occur simultaneously or sequentially depending on the nature of the reaction and the conditions necessary for the reaction.

Reactions, at least in part, can include chemical reaction of the inorganic material mixtures with each other and/or with other process constituents. For example, reaction of two elemental metals at an array location can include oxidation of the metals by atmospheric oxygen present in the environment or by chemical oxidizers present in the combined solution or suspension of materials.

In some embodiments, a reaction takes place when liquids in the materials combination vaporize to leave the inorganic materials concentrated together at the location within the compositional gradient. For example, loss of hydration water can cause some mixtures of materials to react with each other. In other cases, loss of application liquid solvents can expose the materials to external reactants to allow co-reaction of materials with water or oxygen from the atmosphere.

In embodiments where one or more of the inorganic materials is associated with a stabilizing polymer, reactions can take place when the polymer is removed by vaporization. For example, in cases where the inorganic material is associated by ionic interaction with a charged polymer, the material can fail to react with other materials at the location until the polymer is removed by heat. The process of polymer removal can be accelerated by the presence of oxygen in the environment (i.e., the polymer is “burned” away).

In further embodiments, the reaction can include sintering together of the combined inorganic materials on the replicate array substrate. In sintering, the dried liquid solutions are brought together at a temperature below their melting points, but at a temperature high enough for interactions to form solid phase of desired inorganic materials. The result can be a microscopically porous heterogeneous or homogenous crystal structure. In the presence of oxygen, the sintering process can also result in oxidation of one or more of the inorganic materials.

In still further embodiments, the reaction can include melting together of combined inorganic materials. The reaction product of the melting may be in many forms, including an amalgam, a crystal, or an alloy. In some cases, certain inorganic materials will melt together without added heat. In many cases, added heat is required to melt mixed inorganic materials together. In the case of combinations of materials that are each pure elemental metals, the mixed composition can melt at a temperature lower than the melting temperature of either pure metal, due to the effects of colligative properties on melting temperatures. Melting together of pure metals can result in amalgam or alloy reaction products, particularly when the local environment does not contain oxidizing agents. In the presence of oxidizing agents (such as atmospheric oxygen) the melted metals can become oxides, resulting in metal oxide crystal reaction product compositions.

In many embodiments of the invention, reaction of combined materials depends on raising the substrate to a temperature above ambient conditions. For example, reactions can be initiated by heating the substrate to a temperature greater than about 300° C., greater than about 450° C., greater than about 500° C., greater than about 750° C., greater than about 1000° C., greater than about 1200° C., greater than about 1500° C., greater than about 1750° C., or greater than about 2000° C. This can be accomplished by, e.g., heating the substrate in an oven, resistive heating or hot gasses in contact with the substrate, microwave radiation, by radiant heating, etc. In some embodiments, the combined materials can be reacted by heating the materials without substantial heating of the substrate. For example, material combinations at array locations can be rapidly heated to reaction temperatures by exposure to infrared radiation, heated fluids, or laser light.

In some embodiments, reaction and processing can further include epitaxial growth of materials from locations on the array. Combinatorial arrays on substrates can be loaded to chambers for growth of crystals by, e.g., physical vapor deposition (PVD), molecular beam epitaxy (MBE), chemical vapor deposition (CVD) techniques, and the like.

### Systems for Preparing Gradient Libraries

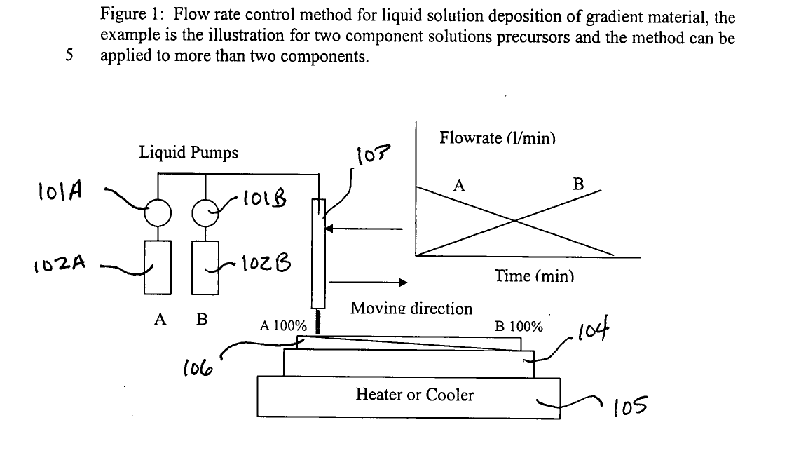

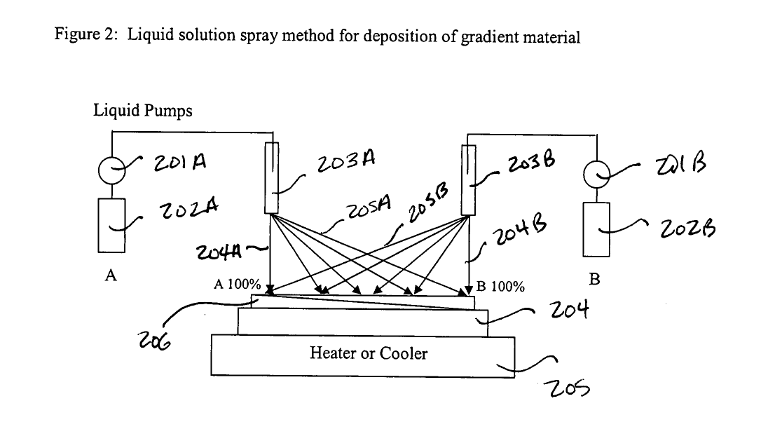

Exemplary systems for preparing liquid solution, gradient-composition combinatorial libraries are illustrated in FIGS. 1 and 2. Such systems may include reactors to allow reactions in the gradient library, as well as detectors to analyze product compositions. In one embodiment, more than one polymer-stabilized liquid solution can be deposited and dried on a substrate, the product deposition having a continuous gradient compositional profile in lateral direction, from one end to the other end of the substrate. A heater in contact with the substrate may be used to evaporate the solvent (and/or water) from the deposited films of materials, and to dry the deposited material immediately after the liquid precursors have been deposited on the substrate.

FIG. 1 shows a flow rate control method for the deposition of liquid solutions as precursors of the gradient library. The example shown in FIG. 1 is for a two-component system of solution precursors, but course it will be understood that any number of precursors may be used. Referring to FIG. 1, liquid pumps 101A and 101B move precursor liquid solutions A and B from reservoirs 102A and 102B, respectively, to a dispenser 103 which may be moved relative to substrate 104 to dispense film 106 on the substrate 104. The substrate 104 may be positioned adjacent to or in contact with a thermal regulating system 105, which may conduct, convect, or radiate heat to the substrate 104 (and hence film 106), or, alternatively, absorb heat from the substrate.

The relative amounts of precursor liquid solutions A and B that are dispensed on the substrate may be varied as the dispenser 103 is moved relative to the substrate 104. In the example depicted in FIG. 1, the dispenser 103 is moved from a first end of the substrate where it dispenses 100 percent A, to a second end of the substrate, where it dispenses 100 percent B. In the middle of its traverse, it dispenses 50 percent A and 50 percent B, and thus the composition changes continuously from A to B across the substrate. The graphical insert in FIG. 1 is a plot of an exemplary flow rate of the precursor liquid solutions (the flow rates in liters per minute, for example) as a function of time. The flow rate of A is at a maximum value at the beginning of the deposition and progresses to a flow rate of zero, whereas the opposite occurs for B.

In an alternative embodiment, depicted in FIG. 2, the dispenser 203A for dispensing liquid solution A is substantially immobile and positioned at one end of the substrate 204, whereas the dispenser 203B for dispensing liquid solution B is also substantially immobile, but positioned at a distant position. Referring to FIG. 2, liquid pump 201A pumps liquid solution A from reservoir 202A to dispenser 203 A, which dispenses liquid solution A according to a pattern where regions of the substrate adjacent to the dispenser receive the maximum amount of A, whereas regions distant from the dispenser do not receive much (if any) of A. Thus the stream of liquid solution A labeled 204A has the greatest effect for A, and the composition of the product film at that location of the substrate will be substantially 100 percent A since the B dispenser 203B is too far away to have an effect on the composition. The pattern of the concentration of B in the product film of course has a mirror image pattern: B has the highest concentration at the right-hand side of the film in FIG. 2 (under B stream 204B), and the lowest at the left-hand side (since stream 205B contributes little or substantially no B to the far left-hand side of the substrate in the figure).

The liquid solutions A and B in the exemplary embodiments of FIGS. 1 and 2 may be any of the polymer-stabilized liquid solutions described in the earlier sections of this disclosure.

In another embodiment, a plurality of polymer-stabilized liquid solutions may be deposited on a substrate and subsequently solidified (including freezing), the resulting film having a continuous composition profile with lateral distance from one region of the substrate to another. A low temperature stage may be used to freeze the deposited precursor material immediately after liquid deposition on the substrate. It may be preferable to carry out this procedure in a vacuum chamber, which allows for evaporation of the freezing liquid solution under the vacuum.

In another embodiment, a plurality of polymer-stabilized liquid solutions may be deposited and crystallized on a substrate, the resulting film having a continuous composition profile in a lateral direction, taken from one region of the substrate to another.

In another embodiment, the production of a product material having a linear composition profile of various increasing and decreasing amounts may be achieved using a method of controlling the liquid solution flows of at least two components by coordinating their depositions with a slot-opening and closing nozzle adjustments.

In another embodiment, the production of a film having a linear composition change (or profile) from one end of the sample to the other may be achieved by controlling one liquid solution spray profile in a transverse direction relative to another liquid solution spray profile.

These systems may include heaters and/or ovens, e.g., to process, dry, or react combinations of materials at array locations. Depending on the materials and desired product compositions, various heaters can be used to dry, chemically react, melt, fuse, crystallize, or sinter two or more materials at an array location.

Systems of the invention can include analytical devices (detecting devices) to determine characteristics of combinatorial array product compositions. Characteristics typically of interest include light excitation and/or emissions profiles associated with composition absorbance, fluorescence, phosphorescence, luminescence, etc.; electronic responses, such as, resistance to electric current flow, piezoelectric effects, rectification, dielectric characteristics, photoelectric effects, junction effects, superconductivity at temperatures, etc.; chemical and biological catalytic activities; crystal nuclei behavior; and/or the like. The analytical devices may comprise ohm meters, fluorometers, volt meters, ammeters, photometers, charge coupled devices, magnetometers, enzymes, microscopes, and the like.

### Analysis of Combinatorial Libraries

Combinatorial libraries of inorganic material compositions may be analyzed to detect array locations having product compositions with desirable characteristics. The method of detection often depends on the characteristic of interest. For example, compositions at gradient locations can have optical characteristics, phosphorescence, crystal nucleation, superconductivity, and/or semiconductor characteristics. Combinatorial compositions at array locations can be examined, such as by spectroscopy, with electromagnetic sensors, by microscopy, by detecting a voltage, by detecting a voltage in response to a pressure, by detecting a voltage in response to exposure to light, by detecting a voltage in response to a temperature, by detecting electrical resistance, by fluoroscopy, and/or the like.

Analysis of inorganic compositions at gradient locations can be sequential or can be carried out in parallel. Compositions can be robotically tested for characteristics, such as resistance to electric current flow, by grounding the substrate and manually or robotically contacting compositions to run a resistance test at each location. Certain optical qualities can be tested in parallel using image processing equipment. For example, phosphorescence can be detected by illuminating a combinatorial array with an excitation wavelength followed by monitoring of array locations for emission of desired light wavelengths using a CCD based camera and video monitor.

In a particular embodiment, two or more combinatorial libraries replicate arrays are prepared and each is processed under different reaction conditions. Analyses of the reaction product compositions can help identify mixture combinations and processing conditions providing compositions preferred for particular uses. For example, one combinatorial library can be treated with a temperature, a time, a pH, a pressure, exposure to a light frequency, exposure to a metal vapor, exposure to a solvent, or exposure to a gas, that is different from treatment of another copy of the combinatorial library. Analysis of the differently processed combinatorial libraries can provide data useful in designing or optimizing manufacturing processes for combinatorial materials in the gradient library. Analysis of the differently processed libraries can identify compositions most suited to a particular application, such as a composition having the most intense phosphorescence at a particular wavelength in response to excitation with a selected wavelength.

What is claimed is:

1. A compositional gradient combinatorial materials library comprising a compositional gradient of at least two polymer-stabilized liquids deposited on a substrate.

2. The compositional gradient combinatorial materials library of claim 1, wherein the gradient is selected from the group consisting of continuous, linear, and non-linear gradients.

3. The compositional gradient combinatorial materials library of claim 1, wherein:
the gradient of the first polymer-stabilized liquid ranges from about 100 percent at a first location of the library, and continuously decreases to about zero percent at a second location of the library;
and wherein the gradient of the second polymer-stabilized liquid ranges from about 100 percent at the second location of the library, and continuously decreases to about zero percent at the first location of the library

4. The compositional gradient combinatorial materials library of claim 1, wherein each of the polymer-stabilized liquids comprises an inorganic material selected from the group consisting of metals, ions, elements, or molecules without carbon-hydrogen bonds in a solution wherein the solvent is selected from the group consisting of an aqueous-based solvent, a polar solvent, an organic solvent, and a hydrophobic liquid solvent.

5. The compositional gradient combinatorial materials library of claim 4, wherein the inorganic material comprises ions, atoms, and compounds of the elements selected from the group consisting of aluminum, antimony, barium, bismuth, boron, cadmium, calcium, carbon, cerium, chromium, cobalt, copper, dysprosium, erbium, europium, gadolinium, germanium, gold, hafnium, holmium, indium, iridium, iron, lanthanum, lead, lithium, lutetium, magnesium, manganese, molybdenum, neodymium, nickel, niobium, palladium, platinum, polonium, praseodymium, rhenium, rhodium, ruthenium, samarium, scandium, selenium, silicon, silver, strontium, tantalum, tellurium, terbium, thallium, thulium, tin, titanium, tungsten, vanadium, ytterbium, yttrium, zinc, zirconium, oxidized forms, chelated forms, carbonates, nitrates, phosphates, chlorides, and acetates thereof.

6. The compositional gradient combinatorial materials library of claim 4, wherein the polymer comprises polyethyleneimine, EDTA, a polyanionic polymer, a polycationic polymer, mixed ionic polymers, a peptide, polyethyleneimine (PEI), heparin, carboxylated polyethyleneimine (PEIC), polyethylene oxide, polyelectrolytes, polyacrylate, perfluorosulphonate, perfluorocaboxylate, acrylamide, polyacrylic acid, polyacrylonitrile, a polynucleotide, a protein, polycarbonate, diethylaminoethyl-dextran, dextran sulfate, polyglutamic acid, polyphosphate, polyborate, nitrilotriacetate (NTA), ethylene diamine tetraacetate (EDTA) groups, poly histidine, DMPS, DMSA, DMSO, Bipyridyl, Ethyleneglycol bis2-aminoethyl tetraacetic acid (EGTA), Hydroxyethylethylenediamine triacetic acid (HEDTA), hydroxyethyl starch (HES), dextran, dextrin, inulin, polyvinyl pyrrolidone (PVP), and polystyrene.

7. A product compositional gradient combinatorial library formed from a reaction between a polymer-stabilized liquid solution and a second polymer-stabilized liquid solution.

8. A system for producing a compositional gradient combinatorial library, the system comprising:
a reservoir of a first polymer-stabilized liquid solution, and a pump connected to the reservoir, for delivering the first polymer-stabilized liquid solution to a dispenser;
a reservoir of a second polymer-stabilized liquid solution, and a pump connected to the reservoir, for delivering the second polymer-stabilized liquid solution to the disperser;
a substrate on which are deposited the first and second polymer-stabilized solutions according to a desired compositional gradient.

9. The system of claim 8, further including a thermal regulatory system adjacent to the substrate for heating and cooling the compositional gradient combinatorial library, and thus causing reaction between the first and second polymer-stabilized liquid solutions.

10. A system for producing a compositional gradient combinatorial library, the system comprising:
a reservoir of a first polymer-stabilized liquid solution, and a pump connected to the reservoir, for delivering the first polymer-stabilized liquid solution to a first dispenser;
a reservoir of a second polymer-stabilized liquid solution, and a pump connected to the reservoir, for delivering the second polymer-stabilized liquid solution to a second disperser, the second dispenser spaced apart from the first dispenser;
a substrate on which are deposited the first and second polymer-stabilized solutions according to a desired compositional gradient.

11. The system of claim 8, further including a thermal regulatory system adjacent to the substrate for heating and cooling the compositional gradient combinatorial library, and thus causing reaction between the first and second polymer-stabilized liquid solutions.

12. A method of producing a composition gradient combinatorial library, the method comprising:
preparing a first and second polymer-stabilized inorganic material solution; and
dispensing the first and second polymer-stabilized inorganic material solutions on a substrate according to a desired compositional gradient.

13. The method of claim 12, further including reacting the first and second polymer-stabilized solutions of the combinatorial library.

14. The method of claim 12, wherein the first and second polymer-stabilized solutions are prepared by:
a) dissolving a polymer in water;
b) dissolving the salt of the desired metal ion in water;
c) mixing the metal ion solution with the polymer solution such that the polymer encapsulates the metal ion in solution.

15. The method of claim 12, further including the addition of ethylenediaminetetraacetic acid (EDTA) to the mixed solutions of step c).

16. The method of claim 12, further including the addition of a salt or a base to the mixed solutions of step c).
